(19) United States
(12) Patent Application Publication
(10) Pub. No.: US 2017/0057626 A1
(43) Pub. Date: Mar. 2, 2017

(54) PROBE ASSEMBLIES FOR AIRCRAFT SECURING SYSTEMS

(71) Applicant: Sikorsky Aircraft Corporation, Stratford, CT (US)

(72) Inventor: Timothy F. Lauder, Oxford, CT (US)

(21) Appl. No.: 15/246,220

(22) Filed: Aug. 24, 2016

Related U.S. Application Data
(60) Provisional application No. 62/209,653, filed on Aug. 25, 2015.

(51) Int. Cl. B64C 25/68; B64F 1/12

(52) U.S. Cl. CPC B64C 25/68; B64F 1/125; B64C 2025/325

(57) ABSTRACT

A probe assembly includes a base body, a first telescoping member coupled to the base body, a second telescoping member coupled to the first telescoping member, and a drive mechanism. The drive mechanism is operably connected between the base body and the first telescoping member to translate the first telescoping member from a capture position to a capture-retracted position for reducing slop between a fitting coupled to an end of the second telescoping member opposite the base body and an arresting beam.

### CROSS-REFERENCE TO RELATED APPLICATION

This application claims the benefit of priority under 35 U.S.C. §119(e) to U.S. Provisional Application No. 62/209,653, filed Aug. 25, 2015, which is incorporated herein by reference in its entirety.

### BACKGROUND OF THE INVENTION

1. Field of the Invention

The present disclosure relates to aircraft ground support equipment, and more particularly to aircraft probe assemblies for recovering, assisting, securing, and positioning aircraft.

2. Description of Related Art

Structures like oil platforms and vessels commonly include landing decks for receiving rotary wing aircraft like helicopters. Some landing decks are relatively small in relation to the rotary wing aircraft operated from the landing deck, which can create technical challenges to landing and securing aircraft to the landing deck, and therefore include recovery, assist, secure, and traverse (RAST) systems. RAST systems are landing assist and secure systems. They provide for assisting landing and securing of an airborne vehicle to the flight deck of a seagoing vessel. RAST systems typically include both vehicle-mounted components and ship-mounted components. The vehicle-mounted components typically include an electrically operated actuator and hoist, which unlatches and extends from the RAST main probe a messenger cable to the vessel flight deck. On the vessel flight deck the messenger cable is fitted to a haul down cable, and with the haul down cable attached, is reeled and retrieved into the airborne vehicle through the main probe. Once retrieved the haul down cable is connected to the main probe, and a vessel-borne winch hauls the airborne vehicle down the vessel flight deck in a controlled manner. The vehicle is then secured to the vessel flight deck.

Such conventional methods and systems have generally been considered satisfactory for their intended purpose. However, there is still a need in the art for improved RAST systems that allow for improved landing and deck handling. The present disclosure provides a solution for this need.

### SUMMARY OF THE INVENTION

A probe assembly includes a base body, a first telescoping member coupled to the base body, a second telescoping member coupled to the first telescoping member, and a drive mechanism. The drive mechanism is operably connected between the base body and the first telescoping member to translate the first telescoping member from a capture position to a capture-retracted position for reducing slop between a fitting coupled to an end of the second telescoping member opposite the base body and an arresting beam.

In certain embodiments, the first telescoping member can be received within the base body. The second telescoping member can be received within an aperture of the first telescoping member. The first and second telescoping members can be displaceable relative to the base body along a translation axis. The first telescoping member can be independently displaceable along the translation axis relative to the base body member. The second telescoping member can be independently displaceable along the translation axis relative to the first telescoping member through application of a preload to a resilient member coupled between the first and telescoping members. For example, a first end of the resilient member can be fixed within an interior of the first telescoping member, and a second end of the resilient member can be fixed within an interior of the second telescoping member.

In accordance with certain embodiments, the drive mechanism can have elements fixed to both the base body and to the first telescoping member. The first telescoping member can have a deployed position and a fully extended position. The drive mechanism can coupled between the base body and first telescoping member to displace the first telescoping member between the deployed and the fully extended position along the translation axis. The capture and capture-retracted positions of the first telescoping member can be disposed along the translation axis between the deployed and fully extended positions of the first telescoping member. The first telescoping member can have a capture-retracted position that is disposed along the translation axis between the capture position and capture-preloaded position.

It is also contemplated that, in accordance with certain embodiments, the fitting include a crenellated ring. The fitting can have an upper surface. In the capture position, the upper surface of the fitting can be separated from a lower surface of the arresting beam by a gap. In the capture-retracted position, the upper surface of the fitting can overlap the lower surface of arresting beam. In the capture-retracted position, and upper surface of the fitting can compressively overlap the lower surface of the arresting beam. It is contemplated that, when the drive mechanism displaces the first telescoping member along the translation axis between the capture-retracted position and the capture-preloaded position, the second telescoping member remain fixed relative to the arresting beam. This can apply a preload to the probe assembly in tension, and snugging the probe assembly to the arresting beam.

It is further contemplated that, in accordance with certain embodiments, the base body can include a trunnion. The trunnion can define a fold axis, and the probe assembly can be pivotable about the fold axis a stowed position and the deployed position. A messaging cable can be received within a bore defined through interiors of the base body and telescoping members for coupling a haul down cable to the probe assembly. Elements of the drive mechanism can be connected to an exterior of the probe assembly. For example, the drive mechanism can include a motor fixed to an exterior of the base body. The drive mechanism can include a gear element like a worm or pinion rotatably fixed to the exterior of the base body for converting motor rotation into telescoping member displacement along the translation axis. The drive mechanism can include one or more rack elements coupled to an exterior of the first telescoping member to intermesh with gear elements of the drive mechanism.

An aircraft securing system includes a probe assembly as described having a controller operative connected to the drive mechanism with a processor and a memory. The processor is communicative with the memory and the memory has instructions recorded on it that, when read by the processor, cause the processor to determine a displacement distance of the first telescoping member between the deployed position and the capture position based on a predetermined valve or the weight of the aircraft mounting the probe assembly, extend the first telescoping member along the translation axis from the deployed position to the capture position according to the determined displacement distance, and retract the first telescoping member along the translation axis from the capture position to the capture-retracted position. In embodiments, the instructions can additionally cause the processor to further retract the first telescoping member from the capture-retracted position to the capture-preloaded position, thereby applying a preload to the first and second telescoping members. The instructions can also cause the processor to pivot the probe assembly from a stowed position to a deployed position.

A method of securing an aircraft to a landing deck includes determining a displacement distance of the first telescoping member between the deployed position and the capture position along a translation axis based on a predetermined valve or the weight of the aircraft mounting the probe assembly. The first telescoping member is then extended along the translation axis from the deployed position to the capture position according to the determined displacement distance for purposes of engaging an arresting beam, and the first telescoping member is then retracted from the capture position to the capture-preloaded position subsequent to the probe assembly engaging the arresting beam.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an exemplary embodiment of a rotary wing aircraft constructed in accordance with the present disclosure, showing an aircraft-mounted probe assembly for a recover, assist, securing, and traverse (RAST) system engaging vessel-mounted elements of the RAST system;

FIG. 2 is a front elevation view of the FIG. 1, showing the probe assembly with the first telescoping member fully extended from the base body and the second telescoping member fully extended from the first telescoping member;

FIG. 3 is a schematic, cross-sectional side elevation view of the probe assembly of FIG. 1, showing a drive mechanism and the probe assembly deployed from the aircraft;

FIG. 4 is a schematic, cross-sectional side elevation view of the probe assembly of FIG. 1, showing the first telescoping member in the capture position;

FIGS. 5A-5C side elevation view of the probe assembly of FIG. 1, showing the probe assembly relative to an arresting beam of the RAST system in the capture position, a capture-retracted position, and a capture-preloaded position;

FIG. 6 shows a method of securing an aircraft to an arresting beam fixed landing deck using a probe assembly.

### DETAILED DESCRIPTION OF THE PREFERRED EMBODIMENTS

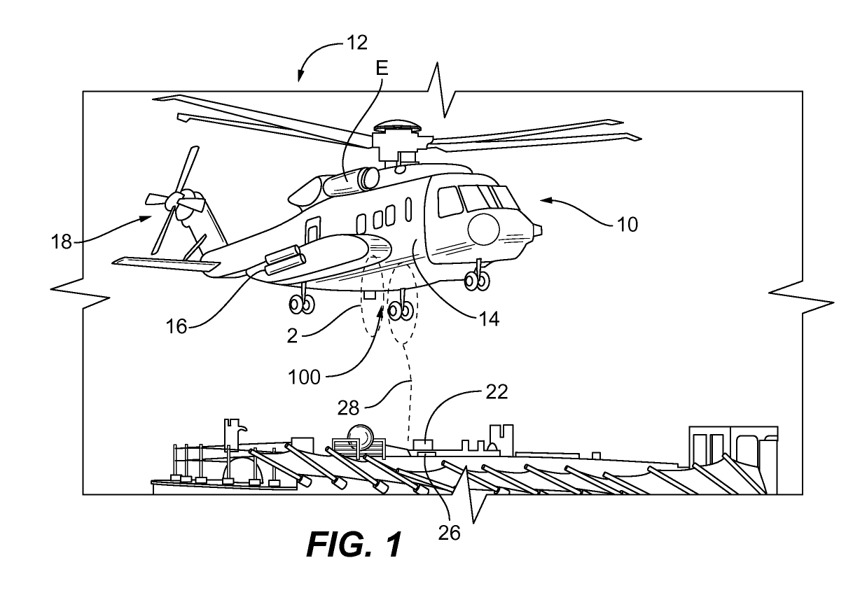

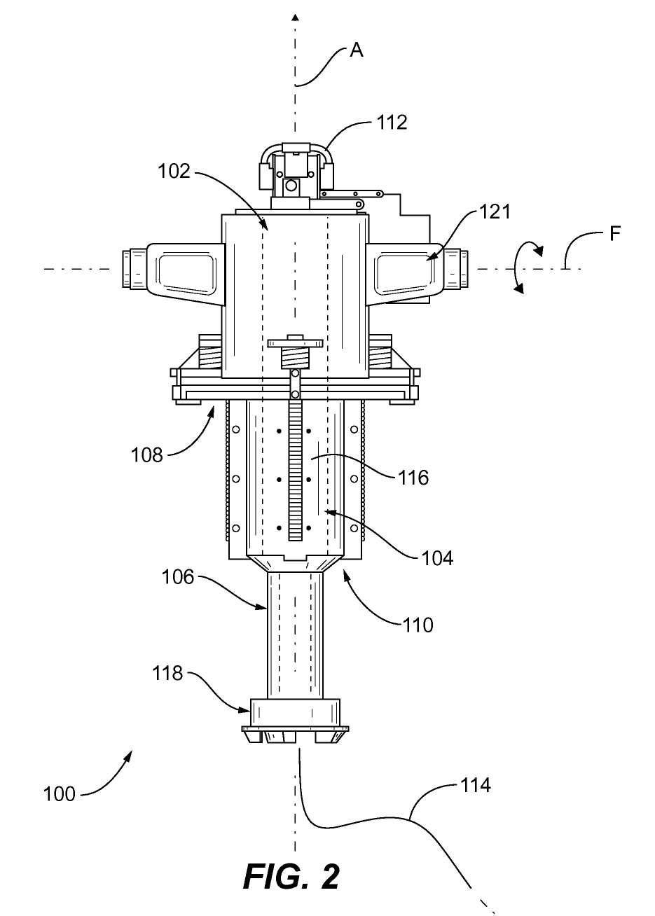

Reference will now be made to the drawings wherein like reference numerals identify similar structural features or aspects of the subject disclosure. For purposes of explanation and illustration, and not limitation, an exemplary embodiment of a rotary wing aircraft mounting a probe assembly in accordance with the disclosure is shown in FIG. 1 and is designated generally by reference character 10. Other embodiments of systems and methods in accordance with the disclosure, or aspects thereof, are provided in FIGS. 2-6, as will be described. The probe assemblies, aircraft securing systems, and methods of securing aircraft described herein can be used in recover, assist, securing, and traverse (RAST) systems aboard marine vessels to snug aircraft like helicopters to an arresting beam on landing deck of the marine vessel. However the invention is not limited to a particular type of aircraft, aircraft RAST system or to aircraft or marine vessels in general.

Referring now to FIG. 1, rotary wing aircraft 10 is shown. Rotary wing aircraft 10 includes a main rotor system 12, an airframe 14 with a longitudinally extending tail 16, and a tail rotor system 18. Tail rotor system 18 includes an anti-torque system and is mounted to tail 16. Main rotor assembly 12 is driven through a main power transmission gearbox (not shown for clarity reasons) by one or more engines E. A probe assembly 100 is pivotably connected to airframe 14 of aircraft 10 for snuggly securing aircraft 10 to a marine vessel. Through a pivoting motion, probe assembly 100 can be stored within airframe 14 and deployed from aircraft 10. When deployed, probe assembly 100 cooperates with a RAST system 22 to snuggly secure aircraft 10 to a marine vessel by cooperating with one or more vessel-mounted RAST elements.

RAST system 22 includes an arresting beam 24 which is fixed relative to a landing deck 26, such as a landing deck of an oil platform or marine vessel. RAST system 22 includes a haul down cable 28 which is connected to a winch on one end (not shown for clarity reasons) and has coupling for engaging probe assembly on an opposite end. During aircraft handling events haul down cable 28 is hoisted from landing deck 26, coupled to probe assembly 100, and reeled in such that rotor wing aircraft 10 is recovered to a predetermined location on landing deck 26. Description of operation of RAST system 22 can be found in U.S. Pat. No. 7,025,304, the contents of which are incorporated herein in their entirety by reference.

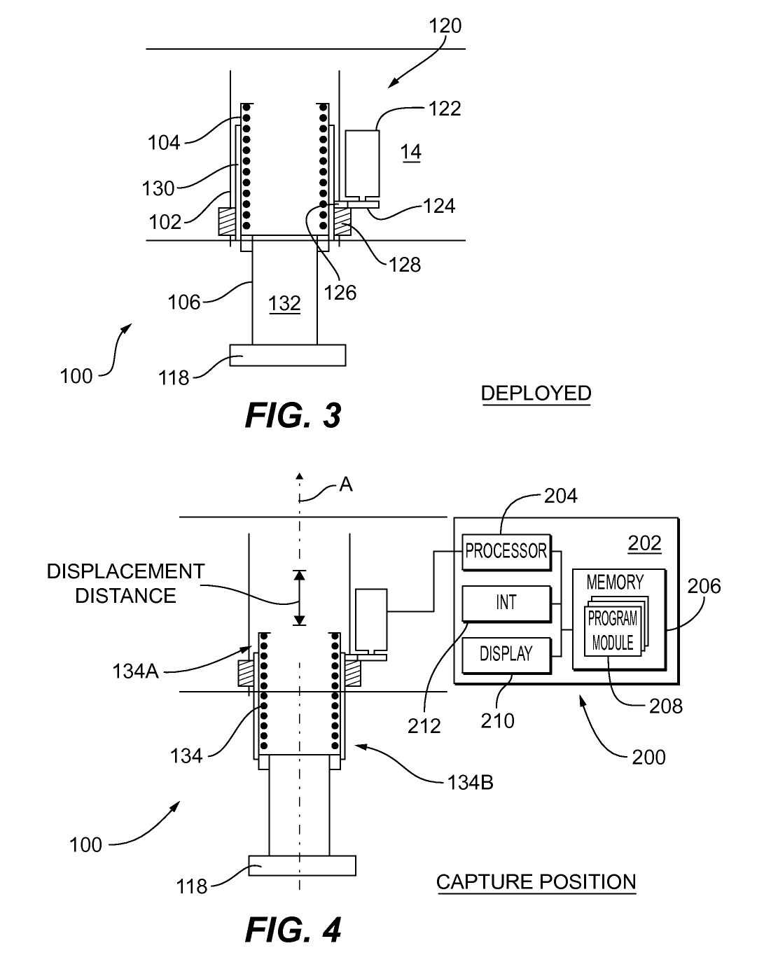

With reference to FIG. 2, probe assembly 100 is shown. Probe assembly 100 defines a translation axis A and includes a base body 102, a first telescoping member 104, and a second telescoping member 106. First telescoping member 104 is coupled to base body 102 and is disposed within an aperture 108 of base body 102. Second telescoping member 106 is coupled to first telescoping member 104 and is disposed within an aperture 110 of first telescoping member 104. Base body 102 includes a trunnion 121 that defines a fold axis F. Probe assembly 100 may be pivoted about fold axis F between a deployed position, wherein probe assembly 100 extends from airframe 14 (shown in FIG. 1), and a stowed position, wherein probe assembly 100 is maintained within airframe 14. As shown in FIG. 3, first telescoping member 104 is substantially enveloped by base body 102 in both the stowed and deployed positions of probe assembly 100. In embodiments, probe assembly may be fixed to airframe 14.

With continuing reference to FIG. 2, a messenger cable reel assembly 112 is seated on base body 102 and includes a messenger cable 114 that can be fed through a bore 116 defined through each of the base body 102, first telescoping member 104, and second telescoping member 106. A fitting 118, illustrated for purposes explanation as a crenellated ring, is disposed on an end of second telescoping member 106 opposite base body 102. Cooperation of messenger cable 114 and haul down cable 28 (shown in FIG. 1) during aircraft retrieval is described in U.S. Pat. No. 7,025,304, the contents of which are incorporated by reference herein in their entirety.

With reference to FIGS. 3 and 4, a drive mechanism 120 of probe assembly 100 is shown. probe assembly 100 is shown in schematic cross-section. Probe assembly 100 includes a drive mechanism 120. Drive mechanism is connected between base body 102 and first telescoping member 104 and has a motor 122, a motor pinion gear 124, a worm pinion gear 126, a worm gear 128, and a rack 130. Teeth of motor pinion gear 124 intermesh with teeth of worm pinion gear 126. Worm pinion gear 126 is fixed in rotation relative to worm gear 128 such that each rotate with one another in convert with rotation with a shaft of motor 122. Teeth of worm gear 128 intermesh with teeth of rack 130. Rack 130 extends linearly along an exterior 132 of first telescoping member 104 such that rotary motion of worm gear 128 is converted to linear translation of first telescoping member 104. Drive mechanism 120 is connected to an exterior of probe assembly, e.g. rack 130 is disposed on an exterior surface 132 of second telescoping member 106, providing access to elements of drive mechanism 120 that may require inspection, servicing, or replacement.

Drive mechanism 120 is configured and adapted to translate first telescoping member 104 along translation axis A. In this respect, relative a deployed position (shown in FIG. 3) wherein first telescoping member 104 is disposed within base body 102, drive mechanism is configured to drive first telescoping member to a fully extended position (shown in FIG. 4) wherein first telescoping member extends from base body by a predetermined distance. In embodiments, the predetermined distance (or throw) of first telescoping member 104 between the deployed position (shown in FIG. 3) and the fully extended position (shown in FIG. 2) is about 8.25 inches (about 21 centimeters). Applicants have determined that throw ranges of around this value provide sufficient flexibility to accommodate the effect of aircraft operational weight range and landing gear height change within the operational weight range to preload probe assembly 100 with sufficient force that the aircraft snugly engages the arresting beam irrespective of aircraft weight change between launch and recovery.

A resilient member 134, illustrated in FIG. 4 in an exemplary manner as a spring, is disposed with probe assembly 100 such that resilient member 134 is fixed within first telescoping member 104 and second telescoping member 106. Resilient member 134 has a predetermined spring coefficient that allows for independent translation of second telescoping member 106 relative to first telescoping member 104, providing passive preposition capability. The preload capability keeps fitting 118 snug with arresting beam 24, preventing displacement of landing deck 26 from imparting sufficient inertia to rotary wing aircraft 10 to displace the aircraft relative to landing deck 26.

With continuing reference to FIG. 4, an aircraft securing system 200 including probe assembly 100 is shown. System 200 is operably connected to probe assembly 100 and includes a controller 202. Controller 202 has a processor 204 that is communicative with a memory 206, and optionally includes a display 210 and/or a user interface 212. Memory 206 has a plurality of program modules 208 recorded thereon with instructions that, when read by processor 204, cause processor 204 to execute certain actions. For example, the instructions can cause probe assembly 100 to deploy from an aircraft airframe by pivoting about a fold axis, e.g. fold axis F, (shown in FIG. 2).

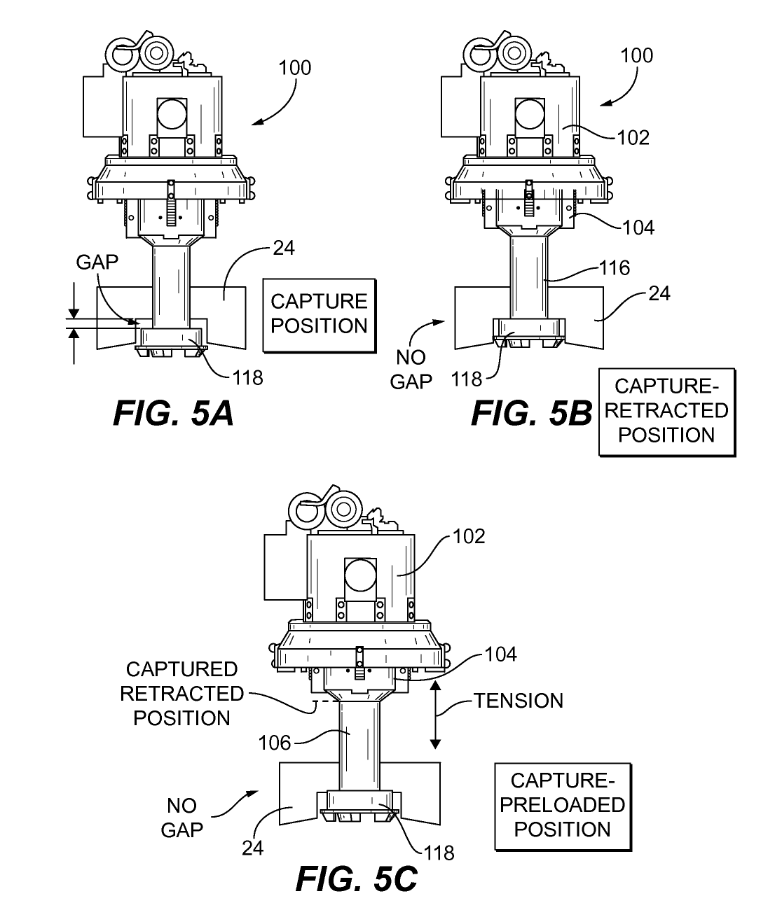

Referring now to FIGS. 5A-5C, the instructions can cause the processor to determine, using aircraft weight, a capture position of first telescoping member, shown in FIG. 5A. In the capture position, first telescoping member 104 is displaced from base body 102 by a displacement distance (shown in FIG. 4) that may cause fitting 118 to be separated from arresting beam 24 by a gap. The gap may be relatively small, e.g. on the order of 0.75 to one (1) inches (20 to 25 millimeters), and can allow an aircraft mounting probe assembly to deflect relative to arresting beam in response to various dynamic effect, such as pitching of the landing deck. The dynamic effects may cause the aircraft to move relative to the arresting beam with sufficient inertia that, when the fitting impacts the arresting beam, shock is transferred into the aircraft sufficient to damage the aircraft. The dynamic effects may also cause lateral movement of the aircraft, causing scrubbing of the landing gear tires on the landing deck, and potentially separating the landing gear tires from the landing gear tire rims.

The instructions recorded in program modules 208 (shown in FIG. 4) also cause the probe assembly to retract both first telescoping member 104 and second telescoping member 106 to a capture-retracted position, shown in FIG. 5B. Retracting both first telescoping member 104 and second telescoping member 106 to a capture-retracted position causes an upper surface of probe assembly fitting 118 to contact a lower surface of arresting beam 24 of a landing deck, closing the gap between the surfaces. The instructions thereafter cause only first telescoping member 104 to further retract to a capture-preloaded position, shown in FIG. 5C, while second telescoping member 106 remains fixed to arresting beam 24. The further retraction of first telescoping member 104 while second telescoping member 106 remains fixed applies tensile load to first telescoping member 104 and second telescoping member 106. This preloads probe assembly 100, more closely synchronizing the dynamics of the landing deck with the secured aircraft, reducing deflections of the aircraft as a result of landing deck movement. As will be appreciated, this reduces aircraft loading as impacts between fitting 118 and arresting beam 24 are reduced. As also will be appreciated, lateral displacements of the aircraft are also reduced, preventing tire scrubbing that could be associated with the lateral displacement which, in certain circumstances, can cause the landing gear tire to separate from the tire rim.

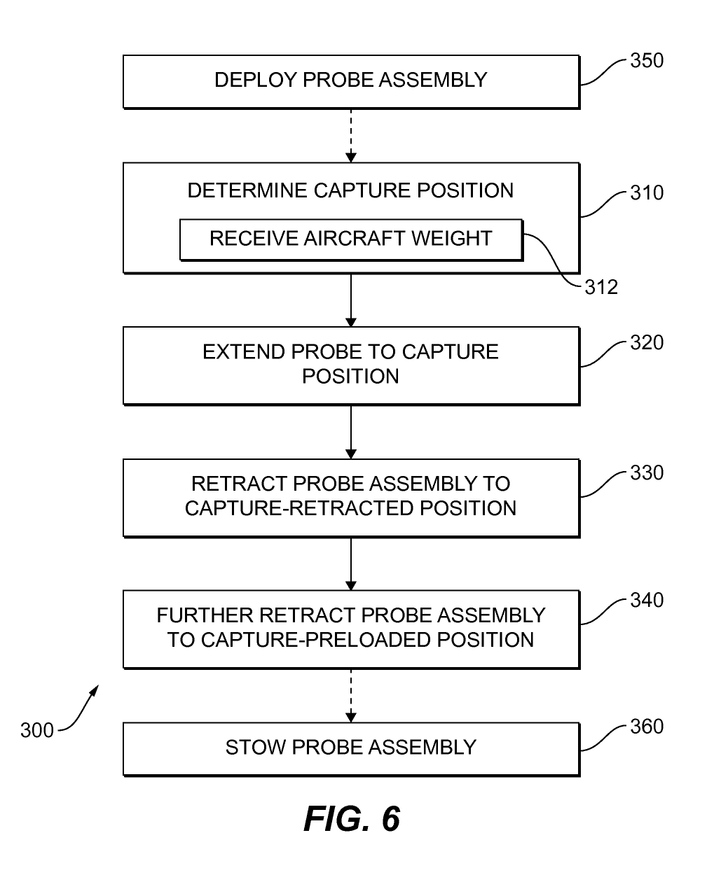

Referring to FIG. 6, a method of securing an aircraft is generally indicated with reference numeral 300. Method 300 includes determining a capture position of a probe assembly, e.g. probe assembly 100 (shown in FIG. 1), as shown with box 310. Determining the capture position can include receiving a predetermined value (i.e. a default extension value) or an aircraft weight, and thereafter determining the capture position using the aircraft weight, as shown with box 312. The probe assembly can then be extended to the capture position according to the determined capture position, as shown with box 320. Extending the probe assembly to the capture position can include translating both the first and second telescoping members, e.g. first telescoping member 104 and second telescoping member 106 (shown in FIG. 2), by equivalent distances along translation axis A (shown in FIG. 2). The probe assembly can be captured by within an arresting beam, as shown in FIG. 5A.

Once captured, the probe assembly is retracted to a capture retracted position (shown in FIG. 5B) by retracting both the first and second telescoping members by an equivalent distances, shown with box 330. The probe assembly is then pre-loaded by further retracting the probe assembly to a capture-preloaded position (shown in FIG. 5C), as shown with box 340. It is contemplated that moving the probe from the capture-retracted position to the capture-preloaded position include translating only the first telescoping member along the translation axis while the second telescoping member remains fixed relative to the arresting beam, compressing the aircraft landing gear system.

The methods and systems of the present disclosure, as described above and shown in the drawings, provide for improve probe assemblies, securing system, and securing methods with superior properties including reducing probe and aircraft loading associated with landing deck dynamics. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A probe assembly, comprising:
a base body;
a first telescoping member coupled to the base body;
a second telescoping member coupled to the first telescoping member; and
a drive mechanism connected between the base body and the first telescoping member and configured to translate the first telescoping member from a capture position to a capture-retracted position for reducing slop between a fitting coupled to an end of the second telescoping member opposite the base body and an arresting beam on a landing deck.

2. A probe assembly as recited in claim 1, wherein the drive mechanism includes a gear element disposed on an exterior of the first telescoping member.

3. A probe assembly as recited in claim 1, wherein the drive mechanism includes a rack connected to the first telescoping member and extending axially along the first telescoping member.

4. A probe assembly as recited in claim 1, wherein the drive mechanism includes a gear element rotatably fixed to the base body and intermeshed with a rack disposed on an exterior of the first telescoping member.

5. A probe assembly as recited in claim 4, wherein the gear element is disposed on an exterior of the base body.

6. A probe assembly as recited in claim 1, wherein the drive mechanism includes a motor operably connected to the first telescoping member and configured to translate the first telescoping member along a translation axis from a deployed position to the capture position.

7. A probe assembly as recited in claim 1, further including a resilient member connected between the first telescoping member and the second telescoping member.

8. A probe assembly as recited in claim 7, wherein the drive mechanism is configured to apply a preload to the resilient member by translating the first telescoping member along a translation axis between the capture-retracted position to a capture-preloaded position.

9. A probe assembly as recited in claim 1, wherein the first telescoping member is received within an aperture of the base body and the second telescoping member is received with an aperture of the first telescoping member.

10. A probe assembly as recited in claim 1, further including a crenelated ring disposed on an end of the second telescoping member opposite the base body.

11. A probe assembly as recited in claim 1, further including a messaging cable extending through a bore defined through the interiors of the base body and telescoping members.

12. An aircraft including a probe assembly as recited in any of the preceding claims, wherein the probe assembly is pivotably fixed an airframe of the aircraft.

13. An aircraft securing system, comprising:
a probe assembly as recited in claim 1; and
a controller operatively connected to the drive mechanism and including a processor communicative with a memory, wherein the memory has one or more program modules recorded thereon with instructions that, when read by the processor, cause the processor to:
determine a displacement distance of the first telescoping member between the deployed position and the capture position along a translation axis based on (a) a predetermined value, or (b) the weight of the aircraft mounting the probe assembly;
extend the first telescoping member along the translation axis from the deployed position to the capture position according to the determined displacement distance, and
retract the first telescoping member along the translation axis from the capture position to the capture-retracted position.

14. An aircraft securing system as recited in claim 13, wherein the instructions further cause the processor to:
further retract the first telescoping member from the capture-retracted position to a capture-preloaded position, wherein the capture-preloaded position is disposed between capture position and the capture-retracted position, and
pivot the probe assembly between a stowed position to the deployed position.

15. A method of securing an aircraft to a landing deck, the method comprising:
determining a displacement distance of the first telescoping member between the deployed position and the capture position along a translation axis based on (a) a predetermined value, or (b) the weight of the aircraft mounting the probe assembly;
extending the first telescoping member along the translation axis from the deployed position to the capture position according to the determined displacement distance, and
retracting the first telescoping member along the translation axis from the capture position to the capture-preloaded position.
